(19) United States
(12) Patent Application Publication
(10) Pub. No.: US 2007/0068919 A1
(43) Pub. Date: Mar. 29, 2007

(54) ELECTRONIC MINIATURE PANCAKE MAKER

(76) Inventor: Keith Byrd, Garfield, NJ (US)

Correspondence Address: STANLEY H. KREMEN, 4 LENAPE LANE, EAST BRUNSWICK, NJ, 08816, US

(21) Appl. No.: 11/539,632

(22) Filed: Oct. 7, 2006

(51) Int. Cl. F27D 11/00

(52) U.S. Cl. 219/401

(57) ABSTRACT

A device that automatically, rapidly, and consistency bakes and browns pancakes (also known as hotcakes, griddlecakes, flapjacks, and French Crêpes) without the use of the traditional frying pan. Convection heating is used to bake the inside of the pancake while radiation heating is used to brown the top and the bottom of the pancake. This device allows individuals unskilled in the art to create consistently cooked pancakes without constant monitoring. The operator simply pours in the pancake batter and presses one single button. The baking and browning process is controlled by two user adjustable timing circuits, the later of which turns the unit off and signals the operator. Low mass components permit rapid warm up and rapid cool down.

### CROSS REFERENCE TO RELATED APPLICATION

Much of the information disclosed herein was also shown in my U.S. design patent application Ser. No. 29/122,679 filed May 2, 2000, now abandoned.

### BACKGROUND OF THE INVENTION

Early methods of making pancakes involved a heavy cast iron flat pan which was placed over a fire. The fire would heat the bottom of the pan using radiation and convection heating. The pan was made of thick heat conductive material such as steel, iron, copper or aluminum which evenly distributed the heat to the top tray surface. This evenly heated surface was required to produce evenly cooked pancakes. Without a thick, highly conductive pan material the pancakes would burn where the fire was the hottest and not cook completely where the fire was not as hot. In recent times electronic heating elements were added inside the thick conductive metal pan, and other improvements added a second heated pan on top to cook both sides of the pancake at the same time. It normally takes quite some time for this heavy metal pan to heat up to the proper temperature and cool down again for cleaning.

A certain level of training and skill is required to make a good pancake. There are two important criteria that must be controlled when cooking a pancake;
1. Baking: The pancake is a type of cakes as the name implies. The pancake mix or “batter” must be evenly “baked” for a period of time which transforms it from a thick liquid to soft cake like material. The volume of the pancake increases during this process which causes it to “rise” (increase in thickness) especially if its diameter is held constant by some predetermined form. The two requirements for baking are a consistent elevated temperature environment and predetermined period of time. The preferred baking temperature is normally between 250 and 350 degrees Fahrenheit. Baking time varies and is dependant on the temperature, pancake mixture and thickness of the pancake. Any variation in time or temperature can create an undesirable uncooked paste like pancake at the low extreme to a hard brittle object at the other extreme.
2. Browning: The top and bottom surface of the pancake must be heated to a much higher temperature to create partial carbonization of the pancakes outmost layer. This caramelization or “Browning” gives the pancake a brown color and increases its hardness which in turn increases the beam strength of the pancake. This increased beam strength improves the handling of pancake so that it will not fall apart when transferred from cooking pan to plate or from plate to mouth. This browning process requires high temperatures normally around 400 degrees Fahrenheit and time. This, like the baking of the pancake has two undesirable extremes. Low browning causes a pancake to be soft and fall apart when handled and excessive caramelization causes a black, hard, brittle surface which is highly undesirable for consumption.

The traditional method of making a pancake involves pouring the pancake mix on an evenly heated surface at a temperature of about 400 degrees Fahrenheit, heated by a variety of power sources, including a flame, electrical elements and natural gas. The pancake mix closest to the pan becomes brown. As you move away from the pan and toward the top of the pancake the temperature drops off, which provides a somewhat uneven but sufficient environment for baking. When the bottom of the pancake reaches the desirable browning level it is flipped upside-down so that the top surface can also be browned to the correct level. This process is technique-sensitive and normally requires some training and trial and error before it is perfected.

The long pan warm up and cool down period and the requirement for constant monitoring makes it rather impractical to make pancakes for one or two people in the morning, especially when they need to get to work.

### DISCUSSION OF PRIOR ART

Previous devices designed for the simplified production of pancakes employ clamshell style designs which require the chef to pour the liquid batter directly onto a heating surface shaped like pancakes which serve the same function as a griddle, with heating elements embedded within both halves of the devices. The devices are closed to apply a cooking surface to both the top and the bottom of the batter to do away with the need to flip the pancakes at the correct time so as to achieve the desired browning and baking of the pancake. Upon completion of the cooking process, the devices are opened and the pancakes removed with a spatula or some similar kitchen utensil.

Several drawbacks exist for these types of devices. Firstly, there is no way to independently choose the desired level of baking and browning for the pancake. The devices are not refined enough to differentiate these two qualities to a skilled cook or pancake maker. Secondly, the use of a cooking surface with embedded heating elements requires a much longer time to warm up the devices and much longer period of time to cool to the point of being safely handled, which precludes its usage by those with limited time. In addition to taking longer to warm and cool, the cooking surfaces remained fixed within the devices, meaning the chef must extricate the finished pancakes by way of spatula or some other similarly functioned kitchen tool from a device that is still dangerously hot.

### SUMMARY OF THE INVENTION

The Present Invention overcomes these challenges by providing a novel means of cooking pancakes that allows for the quick, easy and safe cooking of pancakes meeting the user's desired level of browning and baking. This invention, in its preferred embodiment, provides the user with a convenient electrical cooking device easily capable of sitting on a kitchen countertop. Instead of having heating surfaces built into the device, it employs a low-density, heat resistant tray to allow for rapid heating and cooling upon activation of the device. The tray itself is easily removable from the device and allows the user to safely pour batter or remove the finished pancakes without having to worry about navigating around the dangerously confined space inside a device employing a fixed cooking surface.

The device itself employs thermal radiation produced at varying durations and intensities in order to provide the optimal level of baking and browning for the user. A user seeking a high degree of browning and a low degree of baking, for example, would use the two independent controls to set their preference. The device then undergoes two or more phases of cooking. At least one phase is responsible for the browning, which requires a high level of heat over a certain duration. At least one phase is responsible for baking which employs a lower heat level for an increased duration relative to the browning phase.

The device comprises a top half and a bottom half containing electrical resistive heating elements, though gas fire, wood fire, etc., is also possible. The removable tray contains one or a plurality of wells into which the batter is poured, but the preferred embodiment has either 4 or 9 wells. The tray itself does not have to be the same material as the wells, such as glass wells placed in a wire-mesh tray. When the batter has been poured into the tray, and the tray placed within the device, the device is closed and the user may set his browning and baking preferences. The device alerts the user upon the completion of the cooking process at which point the user safely removes the cooking tray using the heat-resistant handles on its sides. The pancakes are then safely removed from the tray, and the device is instantly ready for the next batch of pancakes.

### BRIEF DESCRIPTION OF THE DRAWINGS

FIG. 1 is an isometric view of the open cooking device showing two possible trays to be used in the device.

FIG. 2 is a front elevational view of the open cooking device containing a breakout section A showing the controls and indicator lights.

FIG. 3 is an isometric view of the closed cooking device.

FIG. 4 is a side elevational view of the open cooking device.

FIG. 5 is an isometric view of the open cooking device with a tray in the proper position for cooking.

FIG. 6 is an isometric view of a wire-mesh tray with removable wells of thin metal.

FIG. 7 is a detailed view of breakout section A from FIG. 2 of the controls and indicator lights of the cooking device.

### DETAILED DESCRIPTION OF THE INVENTION

While the present invention is presented in drawings and description in its preferred embodiment, it should be understood that it is not limited to this single example. Those skilled in the art will be able to perceive this embodiment and deduce additional embodiments.

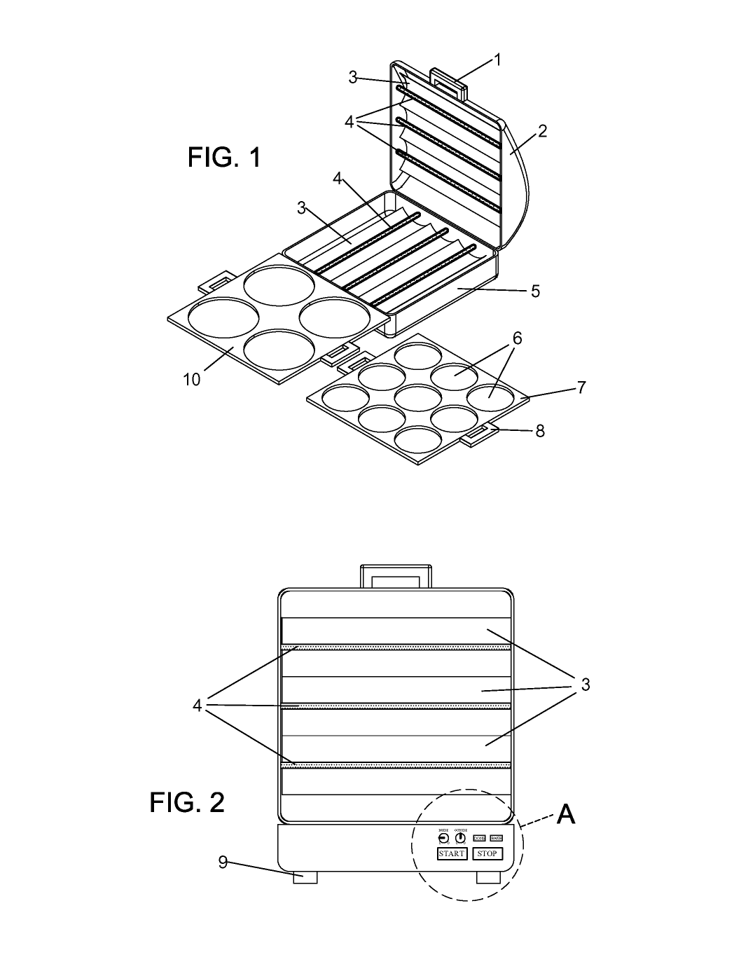

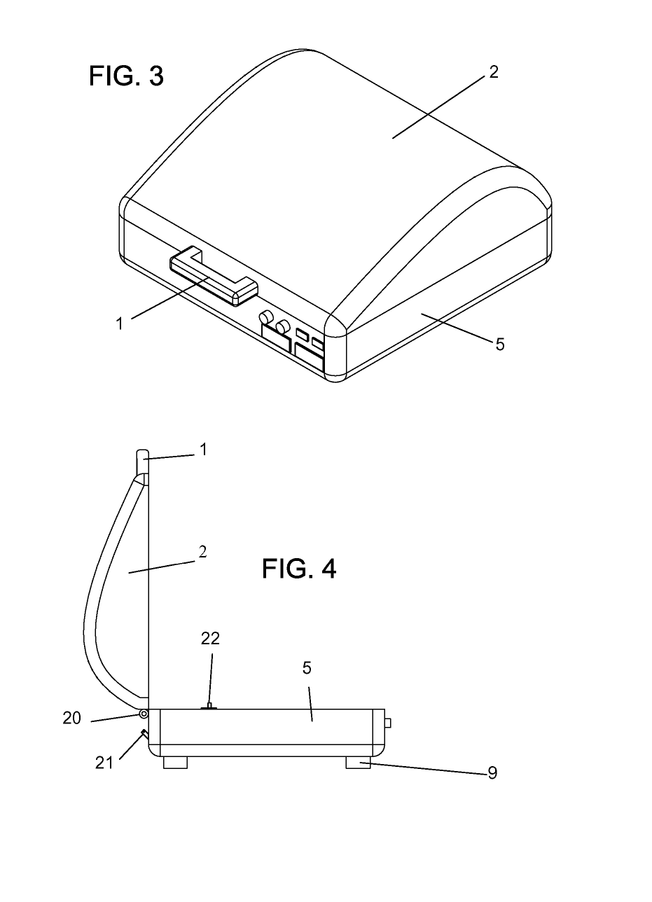

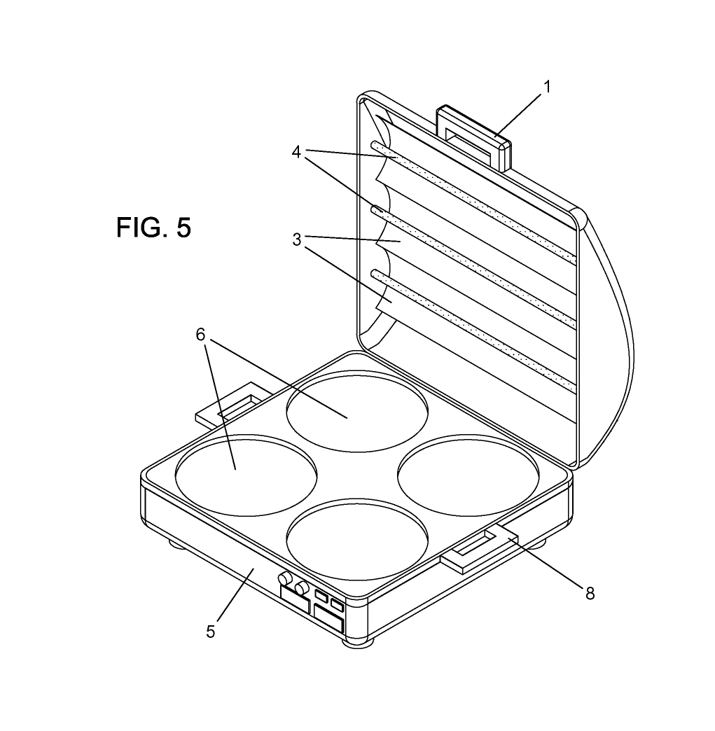

FIGS. 1-5 indicate the preferred embodiment of this invention, a cooking device for making pancakes and the like from liquid batter. FIG. 1 is an isometric view showing the device comprising a base 5 and a top cover 2. Both the base and top cover further comprise at least one electrical resistive heating element 4 and at least one heat reflector 3. The top cover 2 also further comprises a handle 1 located on its top center. FIG. 3 is an isometric view of the device with the top cover in the closed position, and FIG. 4 is a side elevation view of the device with the top cover in the open position. As can be observed in FIG. 3, the plan dimensions of top cover 2 and base 5 are such that cover and base fit together as shown. As shown in FIG. 1, in the preferred embodiment, the longitudinal dimension of the heating elements 4 and heat reflectors 3 for the top cover 2 and the base 5 are perpendicular to each other.

Separate cooking trays 7 and 10 comprise circular wells 6 in a flat plate of similar dimensions as the base 5, which fit between the top cover 2 and base 5 during operation of the device. The material of the plate 7 and wells 6 may be different, such that the wells allow the transmission of infrared radiation while the plate is composed of a low-density, highly heat-resistant material. Handles 8 attached to the center of the sides of the trays 7 and 10 may be composed of yet another material with low heat retention and conduction characteristics.

The top cover 2 is demonstrated as a hollow semicolumnar structure containing one or more electrical resistive heating elements 4 running lengthwise and parallel to the structure's surface. The reflectors 3 are located above the electrical resistive heating elements such that when the device is in the closed configuration shown in FIG. 3 the heat and infrared radiation created by applying electric current to the heating elements are focused downwards in such a way as to provide equal dispersion of heat and infrared radiation.

The base 5 is a flat structure here presented as roughly square in shape. Contained within are electrical resistive heating elements 4 positioned perpendicular to the electrical resistive elements 4 located in the top cover 2 when the device is in the closed configuration of FIG. 3. The reflectors 3 are located below the electrical resistive heating elements 4 in the base 5. The heat reflectors positioned parallel to the electrical resistive heating elements such that when the device is in the closed configuration shown in FIG. 3, the heat and infrared radiation created by applying electric current to the heating elements are focused upwards in such as way as to provide equal dispersion of heat and infrared radiation. On the bottom of the base 5, located at each corner are legs 9 on which the device sits elevated and even on flat surfaces.

As shown in FIG. 2, on the front right of the base 5 are various controls which can be located in any convenient placement for the user of the device, either on the base or the cover. These controls, 12, 13, 16, 17 and indicator lights 14, 15, shown in breakout section A of FIG. 2, are shown in greater detail in FIG. 7. A dial knob 12 indicating the amount of energy focused on baking the inside of the pancakes is located left of a dial knob 13 indicating the amount of energy focused on the baking of the outside of the pancakes. Both knobs rotate independently providing a spectrum from L (light) to D (dark) indicating the brown coloration indicating how thoroughly cooked a pancake is. Below these dial knobs 12, 13 is a single button labeled “START” 16 which, when depressed, activates the device to begin the timer and the cooking process. To the right of the “START” button 16 is a “STOP” button 17 which deactivates the device upon completion of the cooking process. Above this “STOP” button 17 located side-by-side are 2 indicator lights 14, 15 labeled “DONE” and “BAKE,” respectively. The “DONE” light 14 would light upon completion of the baking process while the “BAKE” light would be lit while the device is engaged in the cooking process.

The top cover 2 is attached to the base 5 by a hinge 20 (shown in FIG. 4), which allows for rotation from the open configuration of FIG. 5 to the closed configuration of FIG. 3. An energy source, such as a power cord 21 (shown in FIG. 4) located at the rear of the device will plug into common household A/C electrical jacks and provide power to the electrical resistive heating elements in the top cover 2 and base 5, in addition to the indicator lights 14, 15 and the timing mechanism activated by the “START” button 16. A switch 22 on the rear of the device will act as the main power control, turning the device on or off.

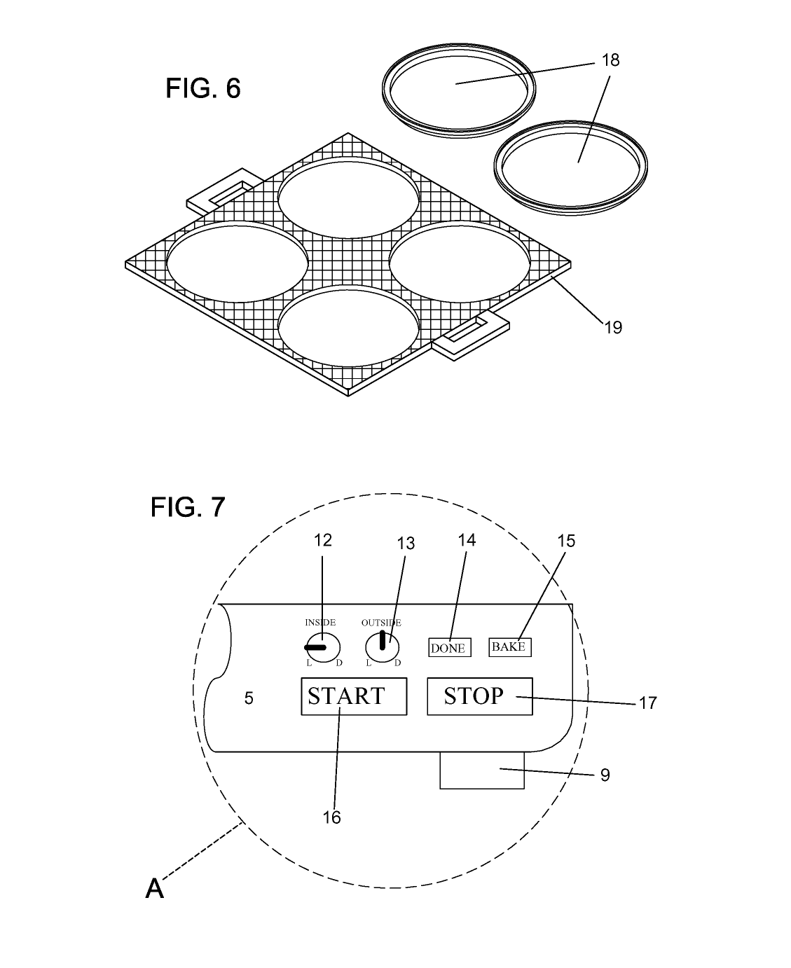

The cooking tray 7 or 10 can be made from any thin heat resistant material. It is preferable to make the tray out of a non-heat conductive, heat resistant material such as phenolic or carbon fiber because it reduces the likelihood that users would burn themselves if they were to touch the cooking tray after it is removed from the oven. In the middle of the cooking tray can be any number of various sized recessed receptacles 6. The pancake mix is poured into each of these receptacles. The receptacles can be an integral part of the cooking tray or an insert 18 made out of some different material. An important part of the receptacle is that it should have either a transparent bottom such as tempered glass or be made out of a thin metal that can easily transfer radiant energy from the lower heating element to the bottom of the pancake. The cooking tray can have some holes in the areas where there are no receptacles. This would allow the hot air above the tray to mix with the hot air below the tray. The tray surface could also be made of a wire mesh 19. This configuration is shown in FIG. 6. Because of the trays' low mass, no preheating is required.

Operation

The user begins by mixing pancake batter as per their own recipe and pouring it into the wells 18 of the cooking tray 19 until there is an even layer over the bottom of each well 18. Next, the tray 19 is placed onto the base 5 and the top cover 2 is lowered to completely enclose the tray within the cooking device. The user then sets the dials for the inside and outside degree of cooking on the front panel via knobs 12 and 13, respectively. The farther along the spectrum towards the “D” (dark) setting, the greater the amount of time spent cooking that particular aspect of the pancake. The outside of the pancake is cooked via radiant radiation that acts primarily on the surface of the batter to quickly brown the outside layer. The inside of the pancake is cooked via convection heating in which the electrical resistive heating elements 4 bring the temperature inside the device to approximately 300° Fahrenheit. To activate the device, the user presses the “START” button 16, which activates a timer based on the two knob settings 12, 13 and switches on power for the electrical resistive heating elements.

When the timer completes its set duration, a ding or similar type of noise to alert the user is made. The user then presses the “STOP” button 17 to terminate the cooking process. As an alternate embodiment, the cooking can be stopped automatically without the need for the user to press the “STOP” button. The top cover 2 is then lifted back into its open configuration shown in FIG. 5, and the tray may be safely removed using the two handles 18 located on its side. The handles 18 should be coated with a heat-resistant covering such as silicon to allow for easy handling immediately after the cooking process. The pancakes are then removed from the wells 18 with a spatula or fork or similarly functional kitchen tool.

I claim:

1. A cooking device for cooking liquid mixtures of ingredients comprising:
a) a tray with wells for receiving liquid mixtures of ingredients;
b) at least one upper heater located above the tray and at least one lower heater located below the tray;
c) an energy source;
d) conduits to transmit energy from the energy source to the heating elements;
e) a browning control configured for a user to select a desired time interval for browning;
f) a baking control configured for a user to select a desired time interval for baking; and,
g) a sequencer which:
initiates and concatenates the browning interval and the baking interval;
increases power to the heaters during the browning interval; and
decreases power to the heaters during the baking interval,

2. The cooking device of claim 1 wherein power to the heaters is increased and decreased by the sequencer increasing and decreasing the supply of energy to the heaters, respectively.

3. The cooking device of claim 1 wherein power to the heaters is increased and decreased by the sequencer supplying a constant energy level intermittently to the heaters and increasing and decreasing the frequency thereof, respectively. whereby the liquid mixture is cooked to a desired finish and consistency.

4. The cooking device of claim 1 wherein the tray is removable.

5. The cooking device of claim 1 further comprising a cover and a base wherein:
the upper heater is contained within the cover;
the lower heater is contained within the base; and,
the cover and base are joined by a hinge,
whereby the device may be opened and closed in the manner of a clam shell.

6. The cooking device of claim 1 wherein the heaters are powered by electricity.

7. The cooking device of claim 1 each heater comprises at least one rod-shaped heating element having a longitudinal axis.

8. The cooking device of claim 1 wherein each heater comprises at least two rod-shaped heating elements having essentially parallel longitudinal axes.

9. The cooking device of claim 8 wherein the heating elements of the upper heater are arranged in a planar array and the heating elements of the lower heater are also arranged in a planar array, the planes of the arrays being essentially parallel to one another and to the tray when the device is closed.

10. The cooking device of claim 9 wherein the longitudinal axes of the heating elements of the upper heater are essentially perpendicular to the longitudinal axes of the heating elements of the lower heater.

11. The cooking device of claim 7 further an upper reflector positioned essentially above each upper heating element and a lower reflector positioned essentially below each lower heating element.

12. The cooking device of claim 11, wherein each reflector is simply curved about an axis parallel to the longitudinal axis of its associated heating element.

13. The cooking device of claim 12, wherein the simple curvature is arcuate.

14. The cooking device of claim 12, wherein the simple curvature is parabolic.

15. The cooking device of claim 12, wherein the simple curvature is elliptical.

16. The cooking device of claim 1 wherein the tray is comprises a low density, high heat resistant material.

17. The cooking device of claim 1 the tray further comprises one or more wells of a material capable of withstanding high temperatures.

18. The cooking device of claim 17 wherein the wells are removable.

19. The cooking device of claim 1 the baking control comprises a knob.

20. The cooking device of claim 1 the browning control comprises a knob.

21. The cooking device of claim 1 wherein the sequencer comprises a momentary switch configured to initiate operation of the device.

22. The cooking device of claim 1 further comprising a switch to deactivate the cooking process.

23. A cooking device for cooking liquid mixtures of ingredients comprising:
a) a tray with at least one means for receiving liquid mixtures of ingredients;
b) at least one upper heating means located above the tray and at least one lower heating means located below the tray;
c) a means for supplying energy;
d) at least two means for transmitting energy from the energy supplying means to the heating means;
e) a means for controlling browning configured for a user to select a desired time interval for browning;
f) a means for controlling baking configured for a user to select a desired time interval for baking; and,
g) a means for sequencing which:
initiates and concatenates the browning interval and the baking interval;
increases power to the heating means during the browning interval; and
decreases power to the heating means during the baking interval,
whereby the liquid mixture is cooked to a desired finish and consistency.

24. The cooking device of claim 23 further comprising an upper means for containing the upper heating means and a lower means for containing the lower heating means, wherein the upper means and the lower means are connected together by a hinging means that permits the device to be opened and closed.

25. The cooking device of claim 24 further comprising a plurality of heat reflecting means, such that each heating means is associated with a reflecting means.

26. The cooking device of claim 13 further comprising a means for controlling the browning interval and a means for controlling the baking interval.
